(19) United States
(12) Patent Application Publication
(10) Pub. No.: US 2008/0046301 A1
(43) Pub. Date: Feb. 21, 2008

(54) System and method for rejecting a proposed commitment

(75) Inventor: Ip-Ming Stephen Law, Piscataway, NJ (US)

Correspondence Address: MORGAN LEWIS & BOCKIUS LLP, 1111 PENNSYLVANIA AVENUE NW, WASHINGTON, DC, 20004, US

(73) Assignee: Wisage Technology, Inc.

(21) Appl. No.: 11/826,390

(22) Filed: Jul. 13, 2007

Related U.S. Application Data
(60) Provisional application No. 60/830,692, filed on Jul. 14, 2006.

(51) Int. Cl. G05B 19/418; G06F 9/46

(52) U.S. Cl. 705/8

(57) ABSTRACT

A system and method that allow an individual or a party to reject a proposed commitment in a structured manner such that clear disclosure of the condition(s) on which the commitment was proposed, on what ground the commitment was rejected, and optionally, revision(s) that are considered necessary for acceptance in subsequent re-proposal is possible.

### CROSS REFERENCE TO RELATED APPLICATIONS

This application claims the benefit of U.S. Provisional Application No. 60/830692, filed on Jul. 14, 2006, which is hereby incorporated by reference in its entirety.

### NOTICE OF COPYRIGHTED MATERIAL IN DISCLOSURE

A portion of the disclosure of this patent document contains material that is subject to copyright protection. The copyright owner has no objection to the facsimile reproduction by anyone of the patent document or of the patent disclosure, as it appears in the Patent and Trademark Office patent file or records, but otherwise reserves all copyright rights whatsoever.

### BACKGROUND OF THE INVENTION

### Field of the Invention

The present invention relates generally to a system and method for commitment rejection and, more particularly, to a system and method for allowing an individual or a party to propose a commitment to another individual or another party for assessment that ends up with a rejection. The grounds and reasons for rejection are captured and are reverted to the individual or party who had proposed the commitment. Suggestions for improvement may also be captured as criteria for acceptance in the next re-submission.

### SUMMARY OF THE INVENTION

A system and method in accordance with the present invention manage one or more reasons that were used as the ground to reject a proposed commitment. In accordance with the system and method, a rejection is comprised of one or more reasons. These reasons are structured explanations as to why the proposed commitment was rejected. The reasons behind the rejection must be understood clearly so that no repetition of the same gap between what was expected and what was committed could occur.

A proposed commitment for acceptance must comprise one or more conditions. These conditions represent the target achievements and their completion criteria the person or persons (delivering-party) are committed to deliver. These conditions are made up by a combination of one or more activity and/or deliverable and their corresponding schedules, resource requirements, and estimated costs of a project plan.

The delivery-party may create one or more conditions and include them in a commitment. When the delivering-party decide to commit themselves to deliver according to the conditions specified in a commitment, they submit the commitment for acceptance. The person or persons (receiving-party) who the commitment is submitted to for acceptance will evaluate all the conditions which are included in the proposed commitment. The receiving-party's expectations would then be matched against the target achievements and their completion criteria as committed by the delivering-party. Rejection will result if a gap is found between what had been committed and what were being expected.

Since all the conditions that were included in a commitment are explicit, clear and unambiguous, they facilitate similar clarity in a rejection as to what ground and what reasons why the proposed commitment was being rejected. The receiving-party will stipulate the details why the proposed conditions fall short of its expectation, and optionally, the receiving-party may also specify its exact expectation for acceptance in subsequent re-proposal of a revised commitment.

Repetition of the same gap in subsequent resubmission of a revised commitment is to be avoided. Automated tracking of the-gap is thus needed. It is possible since what were committed and what were expected are both expressed in a structured manner. Furthermore, changes in expectation can also become track-able.

FIG. 1 is a flow diagram showing the steps mentioned above.

FIGS. 2-6 depict the commitment creation process in a structured manner in order to facilitate the required clarity in the subsequent rejection process.

FIG. 7 shows the rejection process.

FIG. 8 shows a tree structure for a project plan that comprises the conditions of a commitment to facilitate the capture of the reasons behind a subsequent rejection.

FIG. 9 is a process flow diagram depicting the sub-processes involved in a rejection to a proposed commitment.

### BRIEF DESCRIPTIONS OF DRAWINGS

FIG. 1 is a process flow diagram of a commitment from creation to rejection.

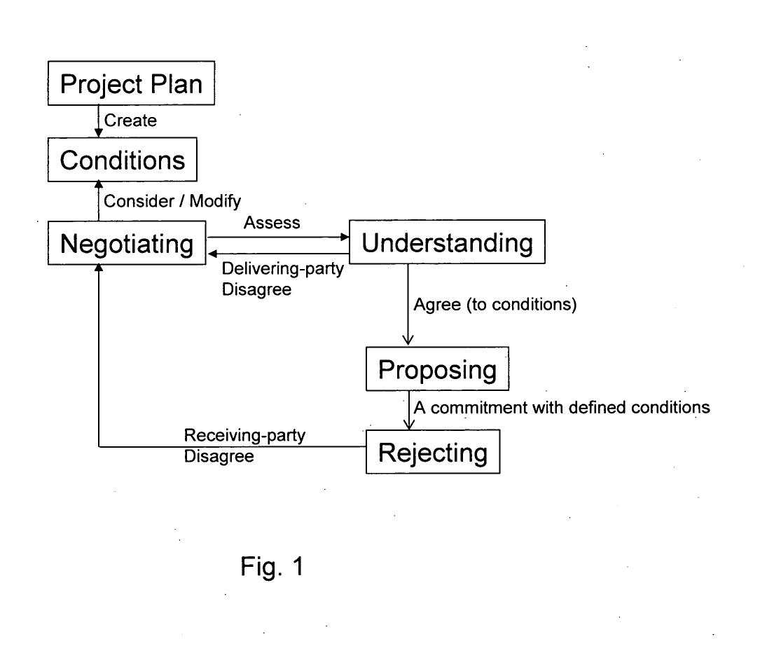

FIG. 2 depicts the underlying substance of a commitment.

FIG. 3 depicts the negotiation process and steps that take place before a commitment is made.

FIG. 4 depicts the self-assessment process that must take place before a commitment is made.

FIG. 5 depicts the understanding process after the self-assessment that must take place before a commitment is made.

FIG. 6 depicts the proposal of a commitment when the delivering-party is ready to commit itself to deliver the target achievements by the completion criteria as specified in the commitment.

FIG. 7 depicts the rejection process made by the receiving-party indicating a gap between what were expected and what were committed.

FIG. 8 shows a structure facilitating the capture of what had been committed and what reasons were behind for a rejection of a proposed commitment.

FIG. 9 explains the process flow in a rejection to a proposed commitment.

### DESCRIPTION OF THE PREFERRED EMBODIMENTS

It has generally been difficult to capture the reasons in a structured manner behind a rejection to a proposed commitment delivering targeted achievements. The lack of a proper structure leads to inability to automate tracking of what is committed and what is expected. Without the knowledge about the gap between what is committed and what is expected, endless repetition of the same gap may happen in subsequent re-proposals. Changes in expectation between proposals may also happen. Representation of the expectation in a structured manner enables automated tracking of them in a precise way.

A need therefore exists for a system and method which can capture the reasons behind a rejection to a proposed commitment in a structured manner. Automated tracking to changes made to what is committed and what is expected is only possible when they are defined and expressed in a proper structure. The present invention suggests such a proper structure.

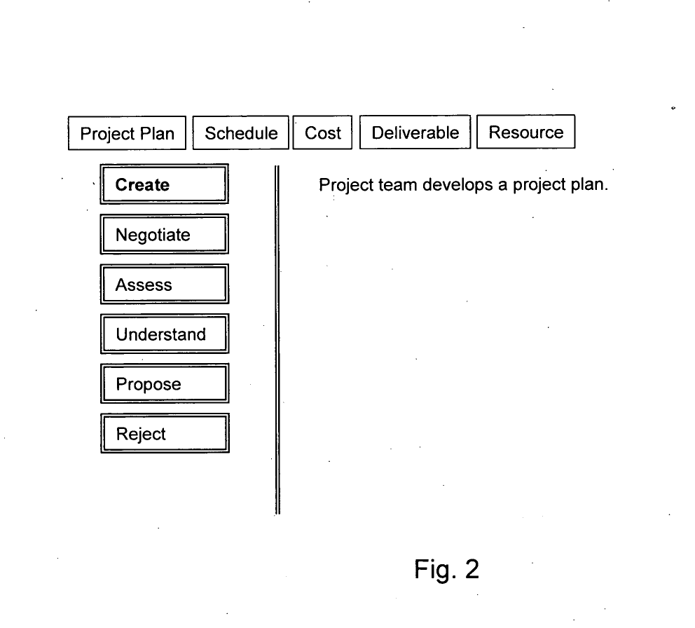

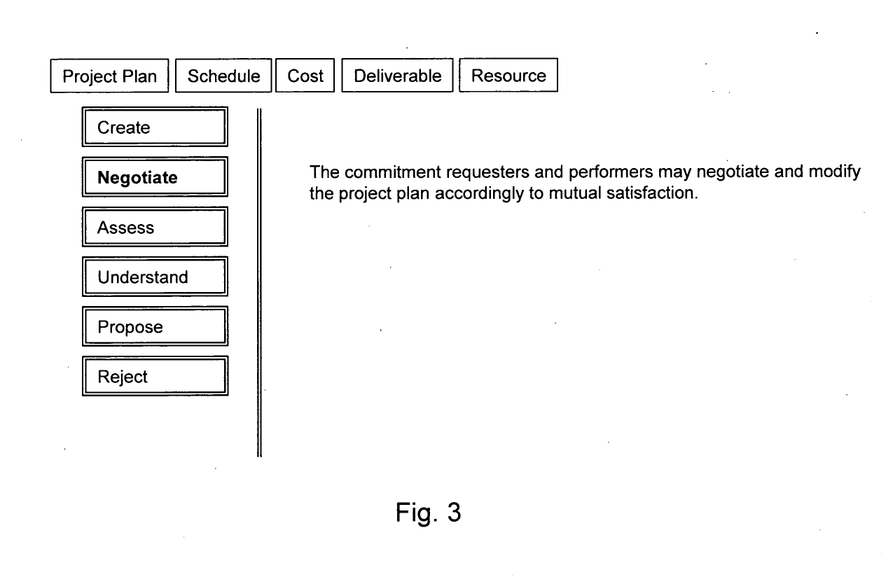

FIGS. 2-6 depict the commitment creation process in a structured manner in order to facilitate the required clarity in the subsequent rejection process. In FIG. 2, Project team develops a project plan. A project plan is made up by one or more activities. Deliverables are also defined and when delivery is expected. Schedules, resources and budget required for their deliveries are being planned and specified. Inter-dependency between deliverables and activities may also be specified to reflect the wanted sequences. In FIG. 3, Project team members may modify project plan in accordance with their requirements and needs. For team members who require to be certain that selected activities and/or deliverables would be completed as planned with defined schedules, resources, and costs, they will need a commitment from those performers who are responsible and accountable for the said activities and/or deliverables. The commitment requesters and performers may negotiate and modify the project plan accordingly to mutual satisfaction.

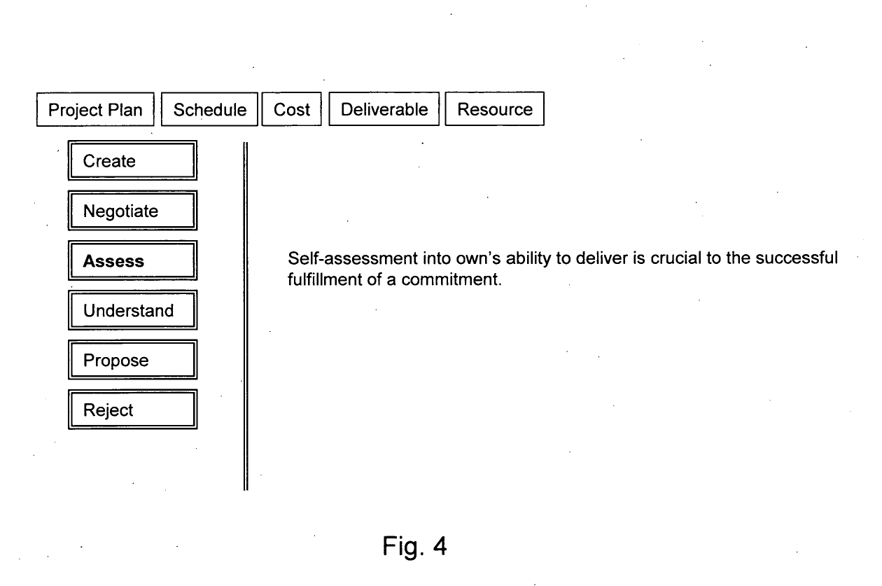

In FIG. 4, a critical success factor for a commitment is that activity and/or deliverable performers know exactly what they are committing themselves into. Self-assessment into own's ability to deliver is crucial to the successful fulfillment of a commitment. Underlying implications of the activities, deliverables, and resources, their dependencies and pre-requisites, and their fulfillment conditions and criteria must be fully assessed. Hence, good organization of the underlying implications, dependencies, and fulfillment criteria is important prior to making a commitment.

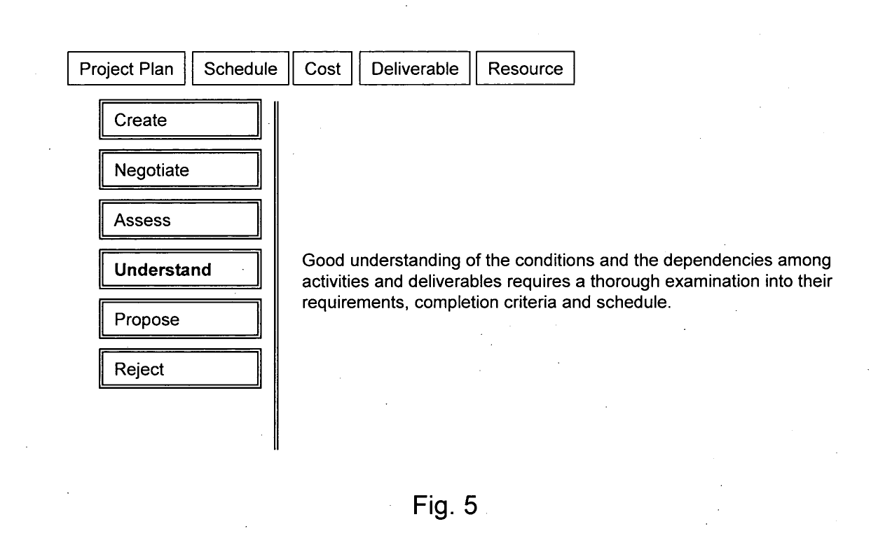

In FIG. 5, good understanding of the conditions and the dependencies among activities and deliverables requires a thorough examination into their requirements, completion criteria and schedule. Dependencies can either be explicit or implicit since not all dependencies are obvious and foreseeable until certain conditions are discovered. Prior to a commitment, a full understanding and agreement to the abovementioned criteria is required since breaking a commitment subsequently is undesirable.

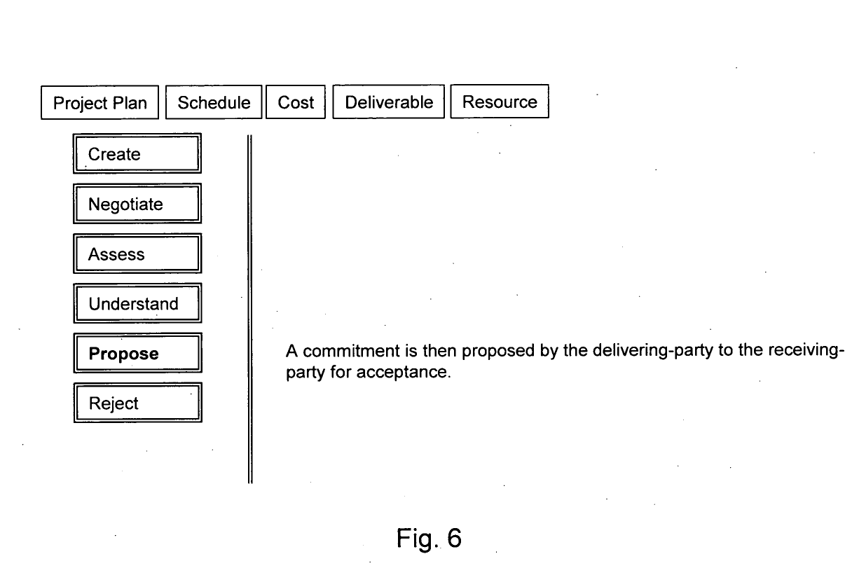

In FIG. 6, only when results from the self-assessment and understanding are positive will a commitment be possible. A commitment is then proposed by the delivering-party to the receiving-party for acceptance. The receiving-party will evaluate if the conditions made satisfy its requirements. The evaluation will be done with ease by showing the committed target achievements and their completion criteria including resources required, estimated cost, schedules, and dependencies. A commitment can be proposed by the delivering-party to multiple persons indicating a one-to-many bilateral commitment.

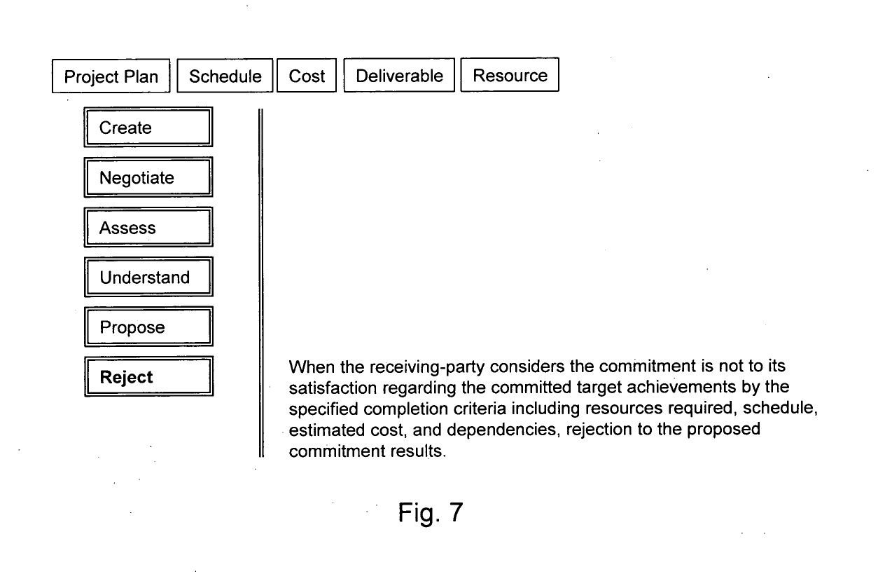

In FIG. 7, when the receiving-party considers the commitment is not to its satisfaction regarding the committed target achievements by the specified completion criteria including resources required, schedule, estimated cost, and dependencies, rejection to the proposed commitment results. The receiving-party shall indicate the deficiencies and the ground for the rejection. Since the commitment was made on clear terms, it would be relatively easy and precise to describe the gap between what had been committed and what is expected. Consequently, the delivering-party may revise the commitment accordingly for subsequent re-acceptance provided that positive results reached from the self-assessment and understanding into its ability to deliver on the revised terms.

A system and method in accordance with the present invention allows a rejection to a proposed commitment to be efficiently managed and tracked. In accordance with one embodiment of the invention, a rejection is comprised of one or more reasons. These reasons are structured explanations as to why the proposed commitment was rejected. The reasons behind the rejection must be understood clearly so that no repetition of the same gap between what was expected and what was committed could occur.

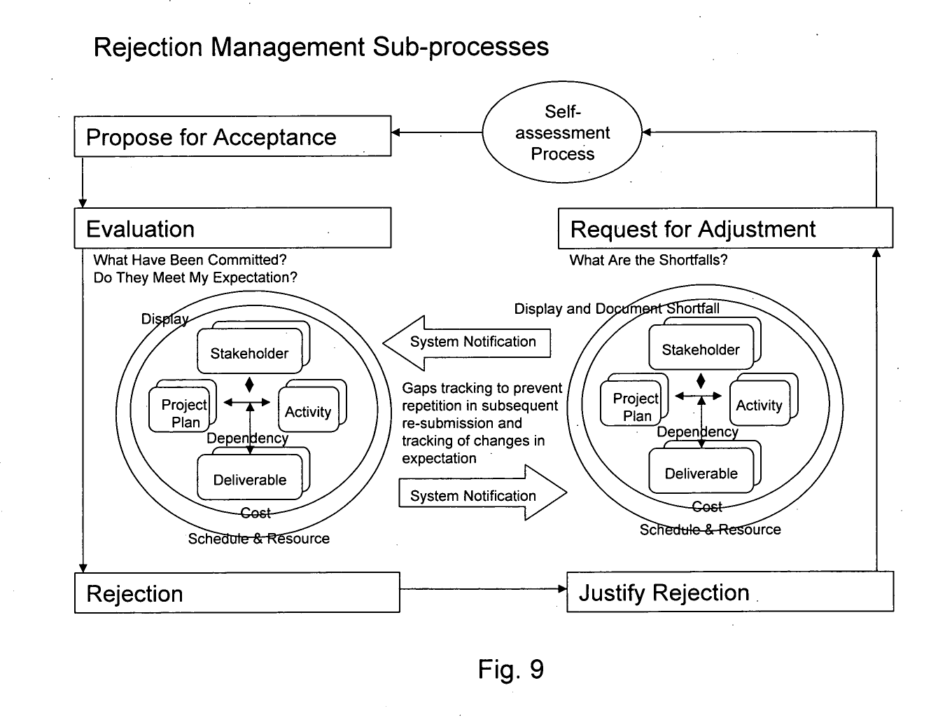

The reasons of rejection are also indications to what was being expected by the receiving-party to the targeted achievements and their completion criteria that are being committed by the delivering-party. These information facilitate the renegotiation process, and the self-assessment and understanding processes of the delivering-party for the next resubmission of a revised commitment. FIG. 9 shows the process flow from a commitment proposal, evaluation of the targeted achievements and their completion criteria, rejection indicating expectations shortfalls, to capturing of the explanations to what the shortfalls are.

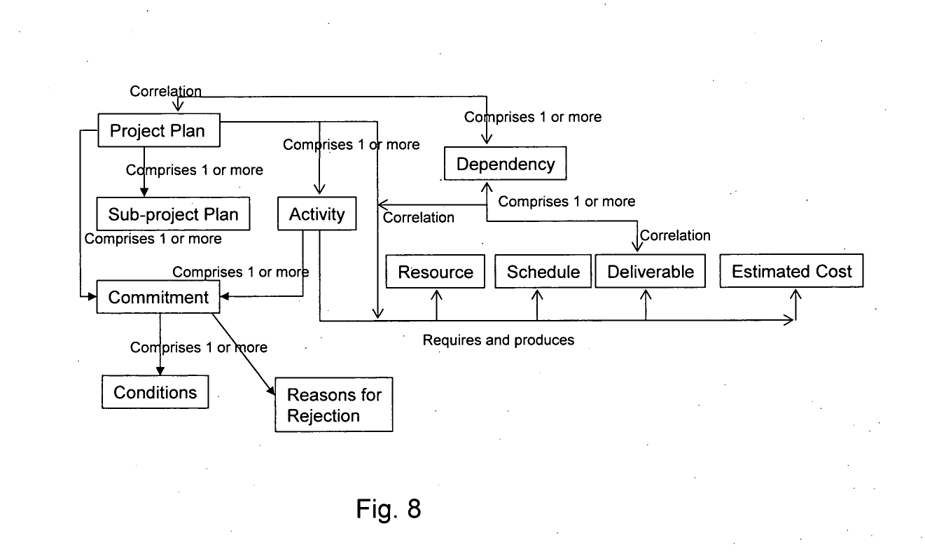

In another embodiment, illustrated in FIG. 8, rejection to a proposed commitment is part of a project plan. The project plan is a tree structure whereby it comprises one or more sub-project plan, activity, resource, deliverable, schedule, estimated cost, and the dependencies among these objects stipulating their correlations and sequences. Commitment and rejection objects are stored as parts of a project plan. In this and all the embodiments, both the receiving-party and the delivering-party are able to access and display the relevant parts of the tree structure that they are authorized for their review of what was committed and why they were rejected.

In accordance with another embodiment of the present invention, automated tracking of what was committed and what was expected in successive proposals and rejections is also supported. This facilitates a clear history of changes made to what was committed to deliver and what was the expectation. It also enables the prevention of repetition of the same gap between successive re-proposals.

It will be readily apparent to one skilled in the art that other various modifications may be made to the embodiments without departing from the spirit and scope of the invention as defined by the appended claims.

What is claimed is:

1. A method for revealing, organizing, understanding, and assessing a proposed commitment and capturing the grounds on which the commitment was rejected, comprising the steps of:
a. revealing the proposed commitment by showing the condition(s) and the basis the commitment was made upon;
b. organizing for better understanding the dependency(ies) and criteria the commitment relies upon for its successful fulfillment;
c. assessing and understanding the commitment proposed;
d. capturing the reason(s) the commitment was rejected; and
e. optionally, capturing the suggested revisions that are considered necessary for acceptance in subsequent resubmission.

2. The method as set forth in claim 1, further comprising the steps of:
a. retrieving a commitment object proposed earlier by an individual or a party to another individual or another party. The commitment object will comprise at least one activity, deliverable, resource, budget, or an acquisition demand that forms the basis of that commitment;
b. presenting the retrieved commitment and its basis for understanding and assessment;
c. capturing the result of the assessment by allowing the assessor to accept or reject the presented commitment object, its basis the commitment was made upon, and the defined conditions that are considered the criteria for fulfillment; and
d. in the event of rejection by the assessor, generating a commitment rejection object and return it to the individual or party who proposed the earlier commitment object.
The rejection record will contain the result of the assessment written by the assessor highlighting the grounds for rejection and optionally, suggestion for improvement for a better chance of acceptance at next re-submission.

3. The method as set forth in claim 2 further comprising the steps of:
a. tracking gaps between what were committed and what were expected;
b. tracking changes in expectations between successive rejections;
c. presenting gaps tracked to avoid repetition of the same in successive commitment proposals; and
d. presenting changes in expectations for better understanding of the rationales behind rejections.

4. The method as set forth in claim 3, further comprising the steps of:
a. testing error and status messages;
b. revising at least one of said activity, said deliverable, said resource demand, said budget demand, said acquisition demand, said fulfillment criteria, or said commitment rejection object upon one of said error or status messages; and
c. repeating said retrieving, presenting, rejecting, testing, and revising steps until none of said error or status messages is received.

5. A system comprising a transaction object for processing said data received by a relational database.
